(19) United States
(12) Patent Application Publication
(10) Pub. No.: US 2009/0114612 A1
(43) Pub. Date: May 7, 2009

(54) UNIVERSAL COLLISION AVOIDANCE OVERRIDE CONTROL SYSTEM FOR OVERHEAD BRIDGE CRANES

(76) Inventor: Roger Gail Nelson, Wichita, KS (US)

Correspondence Address: KANG INTELLECTUAL PROPERTY LAW, LLC, 214 ELM STREET, SUITE 106, WASHINGTON, MO, 63090, US

(21) Appl. No.: 12/261,442

(22) Filed: Oct. 30, 2008

Related U.S. Application Data
(60) Provisional application No. 60/984,520, filed on Nov. 1, 2007.

(51) Int. Cl. B66C 15/06; B66C 23/88

(52) U.S. Cl. 212/276

(57) ABSTRACT

A universal collision override control system for overhead bridge cranes is provided with a logic circuit in communication with a controller for an overhead bridge crane, wherein said logic circuit acknowledges safe zone requirements and overrides safe zone requirements, speed and direction control of the controller of the overhead bride crane.

### CROSS-REFERENCE TO RELATED APPLICATIONS

This Application claims priority of provisional application No. 60/984,520 filed Nov. 1, 2007.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention relates to collision avoidance systems and more specifically to a universal override control system for collision avoidance systems.

2. Related Art

Overhead bridge cranes run on elevated beams or rails (usually high) in a work zone. Overhead bridge cranes move on a pair of parallel runway beams in forward and reverse directions. Perpendicular to the runway beams is the bridge or girder (also called the “crane”). The bridge or “crane” is connected to the runway beams by two end trucks on each end of the bridge. The end trucks can be anywhere from five feet long for a small crane to nearly twenty feet long for a long span crane. The bridge moves in either direction along the runway beams. On the bridge is a trolley, which can move in either direction along the bridge. The trolley can hold a working hoist, which can move up and down. The structure of overhead bridge cranes therefore usually provide 3-axis motion—on an X-axis, Y-axis, & Z-axis.

Floor controlled overhead bridge cranes can be either pendant controlled or radio remote controlled. Crane travel speeds can range from less than 75 FPM to nearly 200 FPM for floor controlled cranes. Generally, overhead bridge cranes traveling at even higher speeds are cab operated (where an operator is located in a cab on the crane) because an operator can not walk fast enough to stay in close proximity with the moving crane.

There may be one or several overhead bridge cranes operating on the same runway. Accordingly, for safety reasons, Collision Avoidance Devices (CADs) are often installed on bridge cranes. These CADs function to prevent operators from inadvertently running (crashing) two cranes together or coming into contact with undesired items.

Overhead bridge cranes may be “crashed” due to at the following factors: 1) untrained operators; 2) careless operators; 3) inexperienced operators; 4) inattentive operators; 5) distracted operators; and 6) occasional equipment control failure.

A Safe Zone is the distance at which an overhead bridge crane must be stopped to avoid contact with another crane or object. A specific Sale Zone (distance) is determined by the crane travel speed (resulting in braking distance), combined travel speeds it two overhead bridge cranes are moving towards each other at the same time, braking method, value of the object or product to be protected, load being handled, brake adjustment, brake wear, drive control method, etc.

To avoid contact between two overhead bridge cranes, one or both overhead bridge cranes may be equipped with CADs. CADs may be based on one or more of the following technologies: ultrasonic; radar; infrared; photoelectric; and laser. These CADs detect the proximity of two overhead bridge cranes to each other, or can even be used to detect other types of obstructions that may lie in the path of an oncoming crane, i.e., building end walls, tall machines, equipment or products, second story offices, etc.

Once proximity to an obstruction is detected, most systems stop the cranes at a given safe distance. This as mentioned above is the Safe Zone. As noted above, a particular Safe Zone distance may be set relatively high due to the various circumstances and conditions involved.

When stopped, the crane can no longer move any farther in the direction it was traveling unless there is some control release method provided (commonly called an “override”).

Overhead bridge cranes at times need to continue (in the same direction as it was traveling) moving closer to another crane or object past the Safe Zone boundary: 1) to perform work close to the second crane; 2) to perform work with the second crane (tandem lifts), and/or 3) to perform work close to a protected item. This is referred to as entering the Safe Zones of the two overhead bridge cranes or objects.

Entering the Safe Zone can only happen if the CAD (which stopped the overhead bridge crane movement) is overridden.

Pendant-operated cranes usually do not have a method of overriding the CAD. If a CAD was added to a pendant-operated crane, it would most likely require an entirely new pendant station (need another push button), some re-wiring, and possible new conductors to incorporate a CAD if one was even available.

Radio controlled cranes may have, as an option, an override system via its radio transmitter. This consists of additional switches, programming, and wiring at some additional cost. Each time a radio system or transmitter is added or replaced (due to damage, age, technology updates), the override option has to be added at a cost to the owner.

One known radio method requires activating two controls (Example—holding down two push buttons) simultaneously to acquire additional crane travel. This is not only physically awkward but also draws the operator's focus from the crane movement to focusing on operating the transmitter.

Another system provided by an overhead bridge crane manufacturer is limited in maximum travel speed allowed, limited in range, and works only with proprietary equipment.

### SUMMARY OF THE INVENTION

The invention is a universal control system that provides for collision avoidance override with added safety features and one which will work with pendant, radio remote, or cab operated overhead bridge cranes.

According to the present invention, there is provided a universal collision avoidance override control system for overhead bridge cranes. The universal collision avoidance override control system includes an interface for operatively connecting and communicating with a collision avoidance system. When the collision avoidance system detects an object in a safe zone, the collision avoidance system stops the overhead bridge crane from moving toward the object. The universal collision avoidance override control system includes a logic circuit that, upon receipt of an override signal, overrides the collision avoidance system, thereby allowing the overhead bridge crane to move toward the object. The logic circuit is operatively connected to the interface.

In a preferred embodiment of the present invention, the universal collision avoidance override control system allows the overhead bridge crane to move toward the object at a restricted speed while the object is in the safe zone.

In a preferred embodiment of the present invention, the universal collision avoidance override control system also includes a signal generator for generating a sensible signal when the collision avoidance system detects the object in the safe zone. Preferably, the signal generator includes an alarm buzzer. The alarm buzzer preferably sounds briefly when the collision avoidance system detects the object in the safe zone. Additionally or alternatively, the signal generator includes a strobe light. The strobe light preferably continues flashing while the object is in the safe zone.

In a preferred embodiment of the present invention, the interface operatively connects the universal collision avoidance override control system to the overhead bridge crane such that the universal collision avoidance override control system can communicate with the overhead bridge crane. Preferably, the interface connects the two systems through an interface wiring.

In a preferred embodiment of the present invention, the logic circuit program is password protected.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a top view of overhead bridge cranes where an embodiment of a universal collision avoidance override control system according to the present invention is installed.

FIG. 2 shows an embodiment of a universal collision avoidance override control system for overhead bridge-cranes according to the present invention.

FIG. 3 is a flow diagram illustrating the decision process in the selection and interfacing of an embodiment of a universal collision avoidance override control system according to the present invention.

FIG. 4A is a control diagram illustrating the crane controls with no collision avoidance system installed.

FIG. 4B is a control diagram illustrating the crane controls with a collision avoidance system installed.

FIG. 4C is a control diagram illustrating the crane controls with a collision avoidance system and a universal collision avoidance override control system installed.

FIG. 5 is a flow diagram illustrating the CLM logic of one embodiment of a universal collision avoidance override control system according to the present invention, wherein the collision avoidance system and the universal collision avoidance override control system are installed on an overhead bridge crane in a forward direction.

FIG. 6 is a flow diagram illustrating the CLM logic of one embodiment of a universal collision avoidance override control system according to the present invention, wherein the collision avoidance system and the universal collision avoidance override control system are installed on an overhead bridge crane in forward and reverse directions.

FIG. 7 is a flow diagram illustrating the CLM logic of an embodiment of a universal collision avoidance override control system according to the present invention, wherein an overhead bridge crane equipped with the collision avoidance system and the universal collision avoidance override control system does not move while another overhead bridge crane moves entering the safe zone.

### DETAILED DESCRIPTION OF THE PREFERRED EMBODIMENTS

Hereinafter, preferred embodiments of the present invention will be described with reference to the accompanying drawings. The description of the preferred embodiments is merely exemplary in nature and is in no wav intended to limit the invention, its application, or uses.

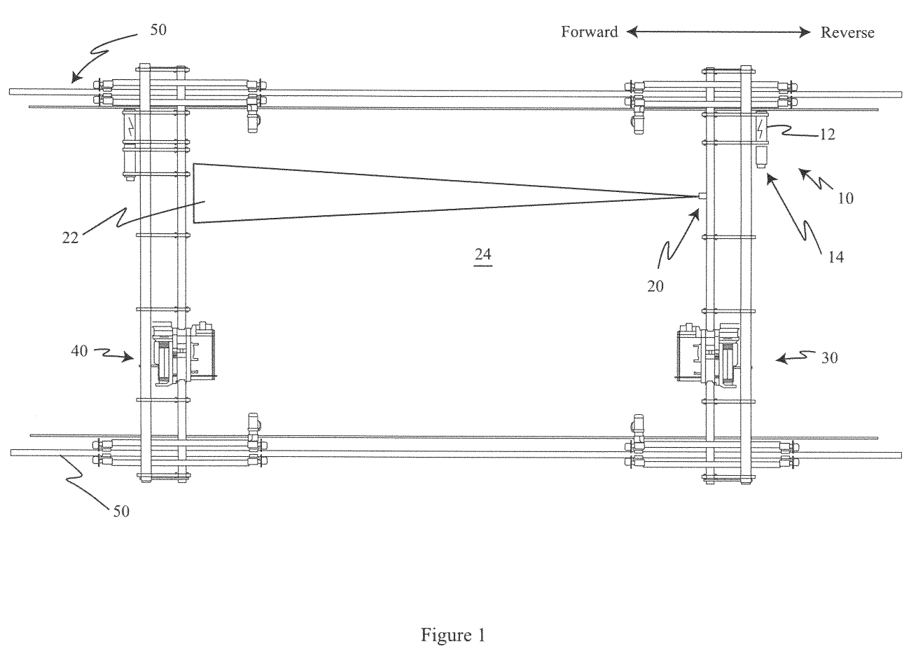

Shown in FIG. 1 are two overhead bridge cranes 30, 40 that run along two parallel crane runway beams 50. In the illustrated preferred embodiment, a Collision Avoidance Device (CAD) 20 and a Universal Collision Avoidance Override Control System (UCAOCS) 10 are connected to the overhead bridge crane 30. No CAD or UCAOCS is connected to the other overhead bridge crane 40. When the CAD 20 detects a neighboring overhead bridge crane 40 within the Safe Zone 24, the CAD 20 is activated and overhead bridge crane 30 movement toward the neighboring overhead bridge crane 40 is stopped. The CAD 20 can use ultrasonic, radar, infrared, photoelectric, or laser 22 in order to detect a neighboring overhead bridge crane 40 or other objects.

The UCAOCS 10 has a Control Logic Module System (CLM) 11. The UCAOCS 10 can preferably be incorporated with any CAD 20. The CLM 11 allows the CAD 20 and UCAOCS 10 to stop the overhead bridge crane 30 movement as desired for the Safe Zone 24 selected, and allows the overhead bridge crane 30 to be moved farther if desired (in the prevented direction). In a preferred embodiment of the present invention, the CLM 11 allows the overhead bridge crane 30 to travel only at its lowest travel speed for safety, and prevents any higher overhead bridge crane travel speed (whether 2-speed or variable frequency controlled). In a preferred embodiment of the present invention, the CLM 11 allows the overhead bridge crane 30 to move at low or high speed when moving Out (reverse direction) of the Safe Zone 24, and allows the overhead bridge crane to move at all speed ranges when not in the Safe Zone 24—no restrictions.

The UCAOCS 10 works with various CADs to therefore allow for various ranges (distances) and methods of detection. The UCAOCS 10 is compatible with existing pendant, radio remote, or cab operated overhead bridge cranes, such that the overhead bridge crane owner does not have to purchase new components (pendant, radio remote system) when adding a CAD to an existing overhead bridge crane on which collision avoidance override is desired and needed. Further, the UCAOCS 10 is integrated so that no special operator actions are required, adapted so that an operator can learn its features quickly, are self-contained and wired into an overhead bridge crane's controls easily by a qualified technician.

In a preferred embodiment as illustrated, the UCAOCS 10 has an alarm buzzer 14 and/or a strobe 12 to trigger sensory receptors with audible and visual signals for not only the operator but for other employees within the work zone. The CLM 11 activates alarms (alarm buzzer 14 and/or strobe 12) on the overhead bridge crane 30 equipped with the UCAOCS 10 when the CAD 20 detects the overhead bridge crane 30 entering the Safe Zone 24 (alarm on time is adjustable but factory pre-set). The CLM 11 preferably keeps the strobe 12 flashing while the overhead bridge crane 30 is within the Safe Zone 24. The CLM 11 can also activate alarms (alarm buzzer 14 and/or strobe 12) when the CAD 20 detects a neighboring overhead bridge crane 40 or any other object enters the Safe Zone 24.

The UCAOCS 10 is preferably preprogrammed and password protected so that unauthorized personnel can not bypass the system logic.

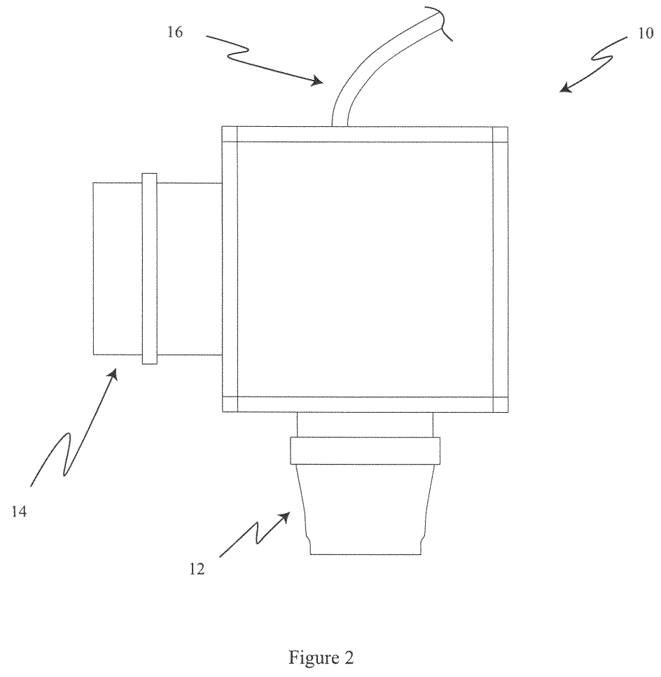

As shown in FIG. 2, the UCAOCS 10 has an interface wiring 16. The advantages of the system are that it is compatible with various CADs (Universal). The system also works with all types of overhead bridge cranes (Universal), is operator friendly, and can be a one (1) direction system (CAD on either forward or reverse crane travel direction) or two (2) direction system (CAD on both forward and reverse crane travel directions). The system also does not require a special control method to utilize it, and can be added later to an existing Collision Avoidance System.

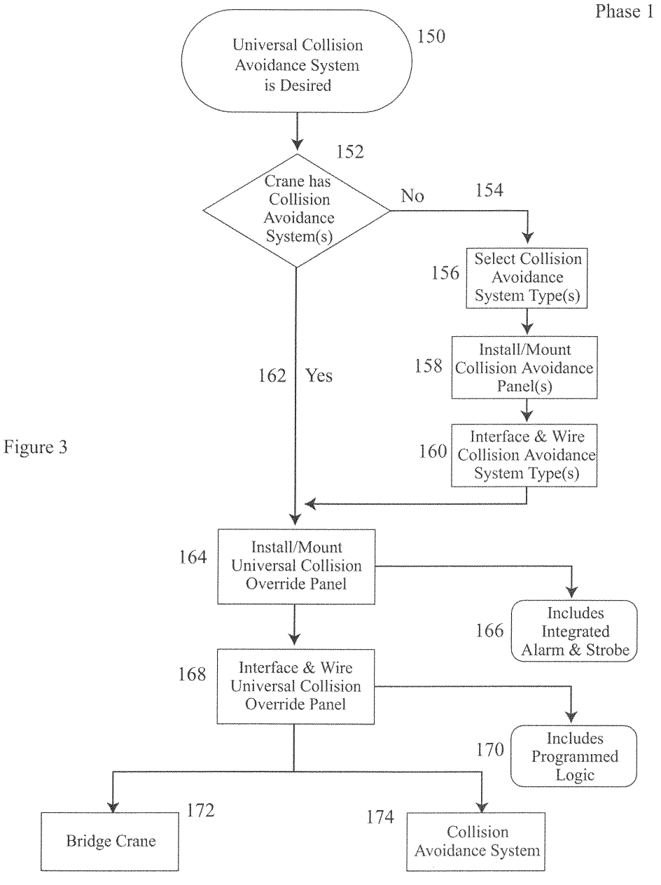

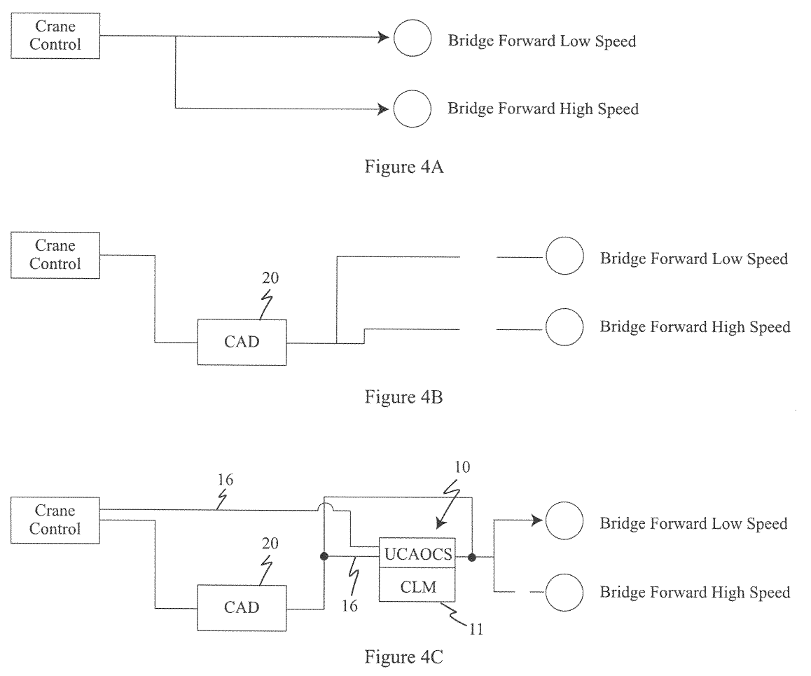

FIG. 3 illustrates the decision process to install a UCAOCS 10 according to the present invention (150). If the crane already has a CAD (152, 162), a universal collision override panel is first installed/mounted (164). The universal collision override panel can include integrated alarm buzzer 14 and/or strobe 12 (166). Then, an interface wiring 16 of the USAOCS 10 is connected (168) to the bridge crane 30 (172) as well as the CAD 20 (174), as also illustrated in FIG. 4C. The system includes a programmed logic connected to the interface wiring 16 (170).

If the crane does not already have a collision avoidance device (152, 154), a CAD is installed by first selecting a proper CAD type (156), then installing/mounting a CAD panel (158), and then by connecting an interface and wire of a CAD (160). After a CAD is thus installed, a UCAOCS 10 is now installed by first installing/mounting a universal collision override panel (164), and then by connecting an interface wiring 16 of the USAOCS 10 (168) to the bridge crane 30 (172) as well as the CAD 20 (174).

FIGS. 4A, 4B, and 4C are control diagrams illustrating the crane controls with no collision avoidance system installed (FIG. 4A), the crane controls with a collision avoidance system installed (FIG. 4B), and the crane controls with a collision avoidance system and a universal collision avoidance override control system installed (FIG. 4C). As shown in FIG. 4A, where there is no CAD installed, the overhead bridge crane 30 operates with no restriction such that the overhead bridge crane 30 can move forward at low or high speed. As shown in FIG. 4B. where there is a CAD 30 installed, the overhead bridge crane 30 cannot move forward into the Safe Zone 24. As shown in FIG. 4C, where there are a CAD 30 and a USAOCS 10 installed, the overhead bridge crane 30 can move forward into Safe Zone 24 only at a low speed.

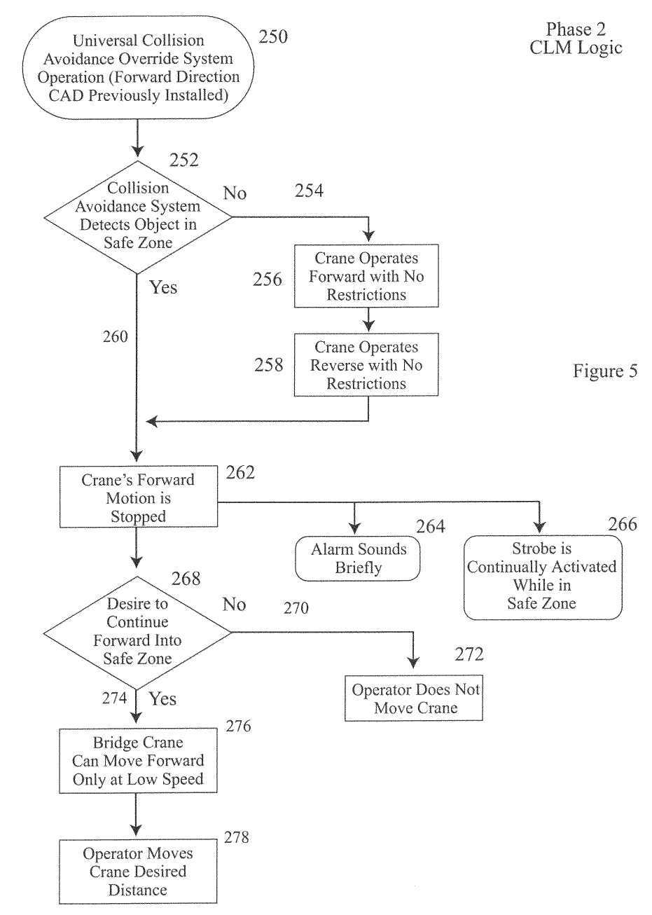

FIG. 5 illustrates how the CLM logic of the USAOCS 10 is operated from the floor where the CAD 20 and the UCAOCS 10 are installed to an overhead bridge crane 30 on a forward direction (toward the neighboring crane 40) (250). When the CAD 20 does not detect the neighboring crane 40 or another object in the Safe Zone 24 (252, 254), the crane 30 operates in the forward direction with no restrictions (256). The crane 30 also operates in the reverse direction with no restrictions (258). However, when the CAD 20 detects the neighboring crane, 40 or another object in the Safe Zone 24 (252, 260), the crane forward movement is stopped (262). Preferably, the alarm buzzer 14 can sound briefly (264). Additionally or alternatively, the strobe 12 is continually activated while the neighboring crane 40 or another object is in the Safe Zone 24 (266).

If the crane 30 is not needed to continue forward into the Safe Zone 24 (268, 270), the operator does not move the crane 30 (272). However, if the crane 30 is needed to continue forward into the Safe Zone (268, 274), the bridge crane 30 can move forward only at low speed (276) until the operator moves the crane 30 to the desired distance (278).

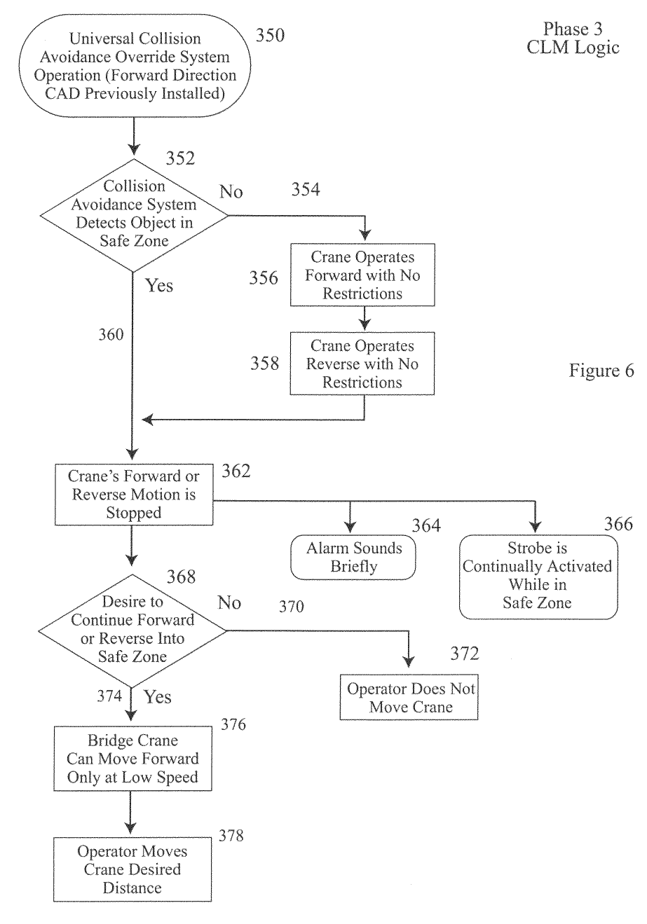

FIG. 6 illustrates how the CLM logic of the UCAOCS 10 is operated where the CAD 20 and the UCAOCS 10 are installed to the overhead bridge crane 30 in forward and reverse directions (350). When the CAD 20 does not detect the neighboring crane 40 or another object in the Safe Zone 24 (352, 354), the crane 30 operates in the forward direction with no restrictions (356). The crane 30 also operates in the reverse direction with no restrictions (358). However, when the CAD 20 detects the neighboring crane 40 or another object in the Safe Zone 24 (352, 360), the crane forward or reverse movement is stopped (362). Preferably, the alarm buzzer 14 can sound briefly (364). Additionally or alternatively, the strobe 12 is continually activated while the neighboring crane 40 or another object is in the Safe Zone 24 (366).

If the crane 30 is not needed to continue forward or reverse into the Safe Zone 24 (368, 370), the operator does not move the crane 30 (372). However, if the crane 30 is needed to continue forward or reverse into the Safe Zone (368, 374), the bridge crane 30 can move forward or reverse only at low speed (376) until the operator moves the crane 30 to the desired distance (378).

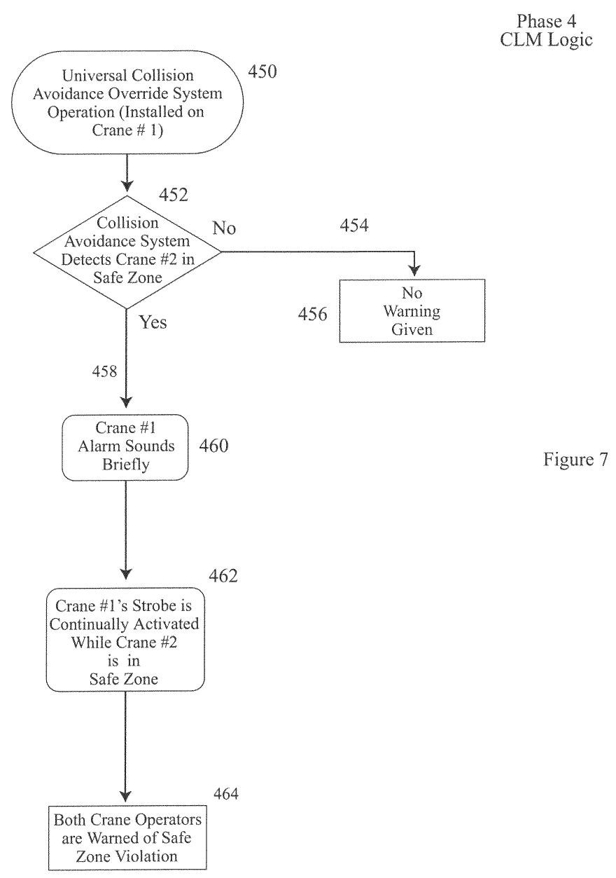

FIG. 7 illustrates how the CLM logic of the UCAOCS 10 is operated where the overhead bridge crane 30 equipped with the CAD 20 and the UCAOCS 10 does not move while the neighboring crane 40 moves entering the Safe Zone 24 (450). When the CAD 20 does not detect the neighboring crane 40 or another object in the Safe Zone 24 (452, 454), the UCAOCS 10 does not provide any warning (456). However, when the CAD 20 detects the neighboring crane 40 or another object in the Safe Zone 24 (452, 458), the alarm buzzer 14 sounds briefly (460). Additionally or alternatively, the strobe 12 is continually activated while the neighboring crane 40 or another object is in the Safe Zone 24 (462). Accordingly, both crane operators can be warned of the safe zone violation (464).

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A universal collision avoidance override control system for an overhead bridge crane, comprising:
an interface for operatively connecting said universal collision avoidance override control system to a collision avoidance system such that said universal collision avoidance override control system can communicate with the collision avoidance system, the collision avoidance system being operatively connected to the overhead bridge crane such that when the collision avoidance system detects an object in a safe zone the collision avoidance system stops the overhead bridge crane from moving toward the object; and
a logic circuit for overriding the collision avoidance system and for allowing the overhead bridge crane to move toward the object when said universal collision avoidance override control system receives an override signal, said logic circuit being operatively connected to said interface.

2. The universal collision avoidance override control system of claim 1, wherein said logic circuit allows the overhead bridge crane to move toward the object at a restricted speed while the object is in the safe zone.

3. The universal collision avoidance override control system of claim 1, further comprising:
a signal generator for generating a signal when the collision avoidance detects the object in the safe zone.

4. The universal collision avoidance override control system of claim 3, wherein said signal generator comprises an alarm buzzer.

5. The universal collision avoidance override control system of claim 4, wherein said alarm buzzer sounds briefly.

6. The universal collision avoidance override control system of claim 3, wherein said signal generator comprises a strobe light.

7. The universal collision avoidance override control system of claim 6, wherein said strobe light continues flashing while the object is in the safe zone.

8. The universal collision avoidance override control system of claim 1, wherein said interface operatively connects said universal collision avoidance override control system to the overhead bridge crane such that said universal collision avoidance override control system can communicate with the overhead bridge crane.

9. The universal collision avoidance override control system of claim 1, wherein said interface comprises an interface wiring.

10. The universal collision avoidance override control system of claim 1, wherein said logic circuit is password protected.
